(19) United States
(12) Patent Application Publication
(10) Pub. No.: US 2023/0236563 A1
(43) Pub. Date: Jul. 27, 2023

(54) Method for Evaluating an Energy Efficiency of a Site

(71) Applicant: ABB Schweiz AG, Baden (CH)

(72) Inventors: Felix Lenders, Darmstadt (DE); Georg Gutermuth, Heidelberg (DE); Bernhard Primas, Mannheim (DE)

(73) Assignee: ABB Schweiz AG, Baden (CH)

(21) Appl. No.: 18/193,863

(22) Filed: Mar. 31, 2023

Related U.S. Application Data
(63) Continuation of application No. PCT/EP2021/076578, filed on Sep. 28, 2021.

(30) Foreign Application Priority Data
Oct. 5, 2020 (EP) 20200081.6

(51) Int. Cl. G05B 19/042

(52) U.S. Cl. CPC G05B 19/042; G05B 2219/2639

(57) ABSTRACT

A method for evaluating an energy efficiency of a second energy consumption scenario of a site includes obtaining a first energy consumption scenario, which comprises a first time-series of energy consumption data of at least one device, and a quality measure of the first energy consumption scenario; obtaining the second energy consumption scenario, which comprises a second time-series of energy consumption data, wherein the second energy consumption scenario has a same or a shorter duration than the first energy consumption scenario; comparing the second time-series of energy consumption data to the first time-series of energy consumption data; and if or when the second time-series of energy consumption data is similar to the first time-series of energy consumption data, outputting the quality measure of the first energy consumption scenario.

### CROSS-REFERENCE TO RELATED APPLICATIONS

This patent application claims priority to International Patent Application No. PCT/EP/2021/076578, filed on Sep. 28, 2021, and to European Patent Application No. 20200081.6, filed on Oct. 5, 2020, each of which is incorporated herein in its entirety by reference.

### FIELD OF THE DISCLOSURE

The present disclosure relates to evaluating an energy efficiency, particularly for industrial or commercial sites.

### BACKGROUND OF THE INVENTION

In many cases, industrial or commercial sites uses enormous amount of energy to run their processes, buildings, and/or further consumers in their sites. Analyzing a site to find energy optimization potential of the site and/or their equipment operation typically requires a deep understanding of the site and may become a time-consuming manual process. On the one hand, data from different data sources, stored in different databases, need to be combined for an analysis of the site's energy consumption. On the other hand, energy optimization of the site requires, at least in some cases, a physical model suitable for an optimization of at least a part of the site. Due to the high complexity and the interdisciplinary nature, obtaining an accurate physical model may be an inherently difficult task.

### BRIEF SUMMARY OF THE INVENTION

It is therefore an objective of the invention to provide an improved method for evaluating an energy efficiency of an energy consumption scenario. This objective is achieved by the subject-matter of the independent claims. Further embodiments are evident from the dependent patent claims and the following description.

One aspect relates to a method for evaluating an energy efficiency of a second energy consumption scenario of a site. The method comprises the steps of: Obtaining a first energy consumption scenario, which comprises a first time-series of energy consumption data of at least one device, and a quality measure of the first energy consumption scenario; obtaining the second energy consumption scenario, which comprises a second time-series of energy consumption data, wherein the second energy consumption scenario has a same or a shorter duration than the first energy consumption scenario; comparing the second time-series of energy consumption data to the first time-series of energy consumption data; if the second time-series of energy consumption data is similar to the first time-series of energy consumption data, outputting the quality measure of the first energy consumption scenario; and controlling the site's power consumption, based on the quality measure.

A site may be an industrial or commercial site (or a part of it), which may run processes, buildings, and/or further consumers in the site. The site may comprise one or more energy consumption scenarios. Each of the energy consumption scenarios may comprise a plurality of data, particularly a time-series of energy data of at least one device. The device may be a machine for any purpose that is run on the site, e.g., a motor, a heater, a cooler, a motor, a computing machine, and/or any energy-consuming device. The device may have one or more—or none—built-in energy-sensors, a plurality of devices may be collected, and their energy consumption may be measured and/or obtained in a collective way. In other words, some devices may provide detailed information—possibly even of their parts and/or components—, other “dumb” devices may only be measured at a common source. The plurality of devices may be organized as disjunctive or overlapping subsets, they may be organized, e.g., as a tree and/or in another topology. The energy consumption scenarios may be obtained by an energy management system (EMS). Some sites may have installed an EMS at least for a part of their devices, thus having “historic” and/or current energy consumption time-series readily available, e.g. as measurement data of electrical (or other) load, possibly either aggregated or distributed into individual load-profile for sub-units. Measurement data may comprise energy data of equipment such as battery, photovoltaic, heating, ventilation, air-conditioning, and/or may others. An EMS may have set-points.

Each first energy consumption scenario may comprise a quality measure of this first energy consumption scenario. The quality measure may be provided in an automated and/or a manual way. The quality measure may comprise any value suited for evaluation, e.g. {A; B; . . . }, {1; 2; . . . }, {“good”; “average”; “bad”; . . . }, and/or further values. The quality measure may comprise an energy consumption, for instance based on a sum of energy consumptions of the devices involved in a scenario for the duration of the scenario. The quality measure may comprise one or more attributes, e.g., an energy-steering sequence (e.g., in an “app”), a comment and/or other informal and/or natural-language part. The first energy consumption scenario may use a set of labelled example time-series or patterns. The same first energy consumption scenarios may represent a class of operation modes, where identical classes specify examples that show the same kind of efficiency or inefficiency. The first energy consumption scenarios may be limited to the worst (“inefficient”) or the best (“best practice”) operation modes.

While the first energy consumption scenario may be considered as “examples”, the second energy consumption scenario may be considered as “real-life probes”. The second time-series may be shorter than the first time-series or may, at max, have the same time duration as the first time-series. The first and second time-series may have essentially the same temporal resolution or may be adapted to the same temporal resolution.

The comparing may relate to a time-series of only one device, e.g., comparing a day-and-night scenario of the second time-series with one of the first time-series, or comparing a frequent on-off-switching, which may have been classified as inefficient. The comparing may relate to a time-series of several devices, e.g., to a heater and a cooler. Running these devices together, e.g., in the same room, may have been classified as inefficient. The comparing may comprise a time-series of input-devices and/or sensors, e.g., reflecting environment data such as temperature, angle of the sun, wind, etc.

When the comparing comes to the result that the second time-series of energy consumption data is similar to (at least one of) the first time-series of energy consumption data, the quality measure of the first energy consumption scenario may be output, possibly including one or more attributes. This output may be used for controlling the site's power consumption, based on the quality measure. The controlling may be done in a “semi-automated way”, for instance by giving hints to an operator how to run the site's energy consumers and/or related devices. The controlling may, additionally or as an alternative, be done in an automated way, i.e., the method described may be integrated in a controlling loop, which controls the site's energy consumers and/or the related devices.

This may advantageously lead to a significantly improved method for evaluating an energy efficiency of an energy consumption scenario. Moreover, both a quantitative and a qualitative basis may be provided for fast improvements on the energy efficiency of the site or parts of it. This may even serve as a basis for an “intelligent” steering or controlling of the site's power consumption. At least in some cases, large datasets that are recorded “standardly” by several EMS, may be used systematically to exploit flexibilities to realize improvements in operation of equipment.

### BRIEF DESCRIPTION OF THE SEVERAL VIEWS OF THE DRAWING(S)

FIGS. 1a and 1b schematically illustrate an obtaining of a first and a second energy consumption scenario according to an embodiment of the present disclosure.

FIG. 2 schematically illustrates a workflow according to an embodiment of the present disclosure.

FIG. 3 is a flowchart for a method according to an embodiment of the present disclosure.

### DETAILED DESCRIPTION OF THE INVENTION

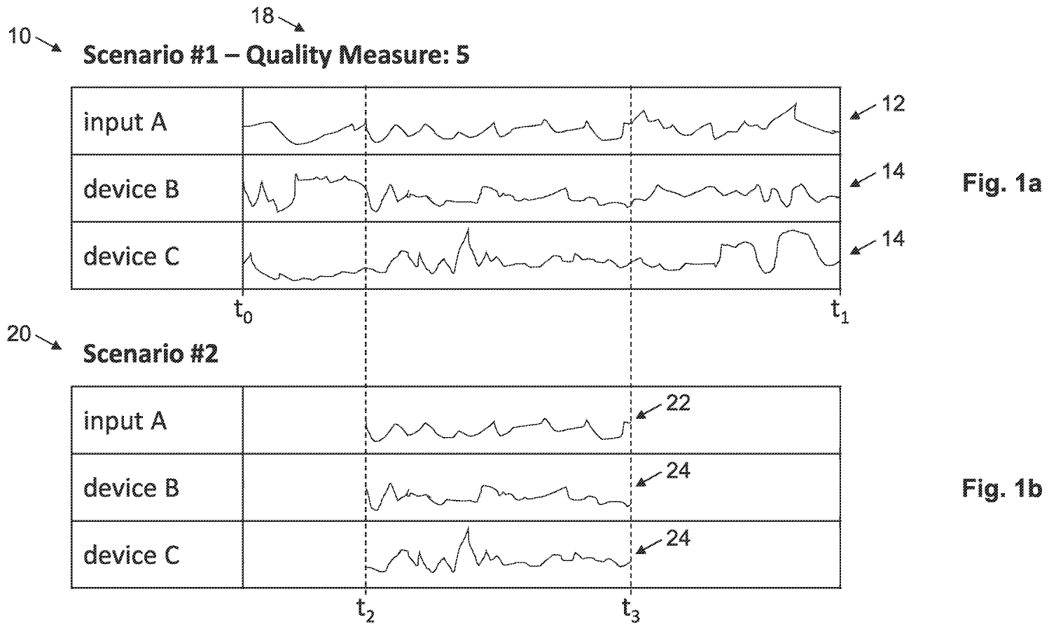

FIG. 1a schematically shows an obtaining of a first energy consumption scenario 10 and FIG. 1b an obtaining of a second energy consumption scenario 20 according to an embodiment. In the example shown, the first energy consumption scenario 10 comprises a first time-series of energy consumption data 14 of device B and device C and input-data 12 of an input A. The data—although shown in an “analogue” way—comprise time-series of digital data, whose values have been obtained from a time t0 to a time t1. In addition, the first energy consumption scenario 10 comprises a quality measure 18, namely “5”. The quality measure 18 may have been obtained automatically and/or manually, e.g., by an energy assessment.

The second energy consumption scenario 20 of FIG. 1b has been obtained from a time t2 to a time t3, after the obtaining of the first energy consumption scenario 10. The second energy consumption scenario 20 comprises a second time-series of energy consumption data 24 of device B and device C and input-data 22 of an input A. As can be seen from these figures, the second energy consumption scenario 20 has a shorter duration than the first energy consumption scenario 10. After obtaining the second energy consumption scenario 20, this is compared to the first energy consumption scenario 10, i.e., to the first time-series of energy consumption data 14 of device B and device C and input-data 12 of an input A. In the case shown, the second time-series of energy consumption data 24 is similar to the first time-series of energy consumption data 14, Thus, the quality measure 18, i.e., “5”, of the first energy consumption scenario 10 is output. The comparison of energy consumption scenario 20 may be done with a plurality of first energy consumption scenarios 10. This may, e.g., be used for studying different “reactions” of devices of the site, possibly depending on a variety of factors. In cases when the quality measure 18 is attributed with a comment or a hint, this may be used for systematic improvements of the energy consumption of the site.

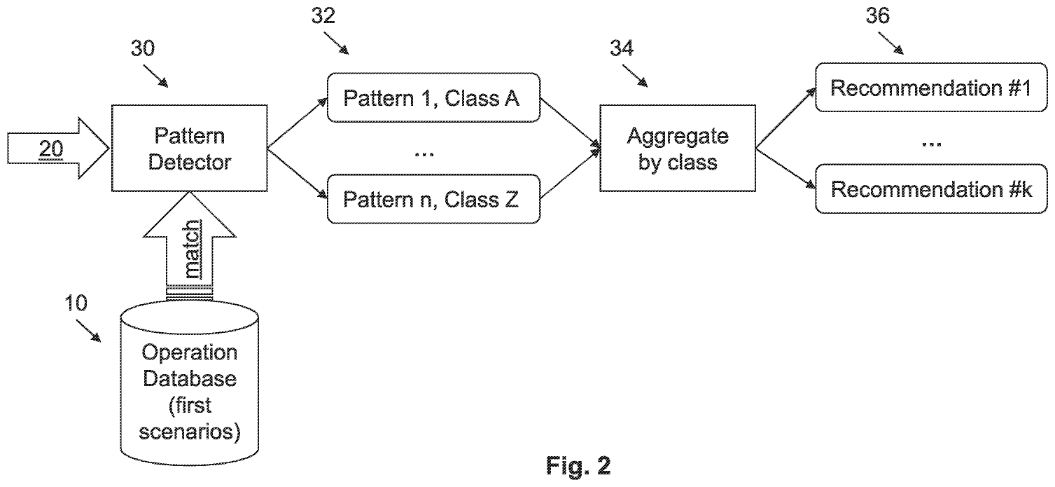

FIG. 2 schematically shows a workflow according to an embodiment. In an Operation Database, a plurality of first energy consumption scenarios 10 (see FIG. 1) is stored. After obtaining a second energy consumption scenario 20, this is compared by a Pattern Detector 30 to the first energy consumption scenario 10. After a successful match of the second energy consumption scenario 20 to a first energy consumption scenarios 10 of the Operation Database, the Pattern 32 or scenario matched is output, along with a quality measure, i.e., in the case shown with a class. The matched Patterns 32 with the same class may be aggregated 34, and, based on this, Recommendations 36 for improving the energy consumption may be output. The improving may be done in a “semi-automated way”, for instance by giving hints to an operator how to run the site's energy consumers and/or related devices. The controlling may, additionally or as an alternative, be done in an automated way, i.e., the method described may be integrated in a controlling loop, which controls the site's energy consumers and/or the related devices.

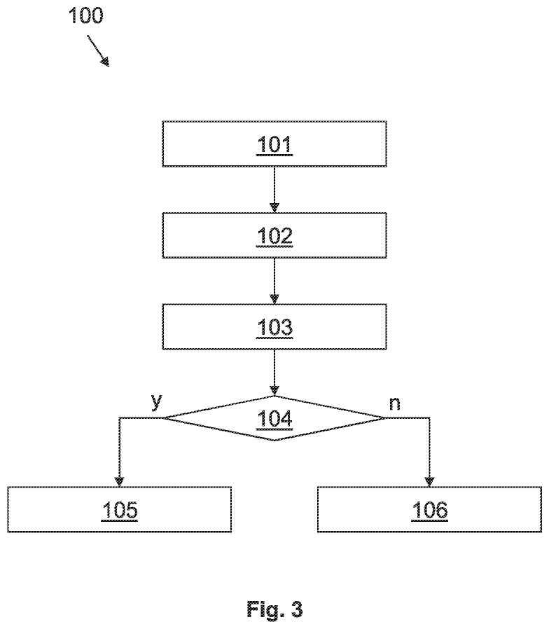

FIG. 3 depicts a flow diagram 100 according to an embodiment. In a step 101, a first energy consumption scenario 10 (see FIG. 1) is obtained, which comprises a first time-series of energy consumption data 14 of at least one device, and a quality measure 18 of the first energy consumption scenario 10. In a step 102, a second energy consumption scenario 20 is obtained, which comprises a second time-series of energy consumption data 24. The second energy consumption scenario 20 may have the same or a shorter duration than the first energy consumption scenario 10. In a step 103, the second time-series of energy consumption data 24 to the first time-series of energy consumption data 14 are compared (see FIG. 2). In cases when the second time-series of energy consumption data 24 is found similar to the first time-series of energy consumption data 14, the quality measure 18 of the first energy consumption scenario 10 is output.

### LIST OF REFERENCE SYMBOLS

10 first energy consumption scenario

12 input-data

14 consumption data

18 quality measure

20 second energy consumption scenario

22 input-data

24 consumption data

30 Pattern Detector

32 matched Patterns

34 aggregated classes

36 Recommendations

100 flow diagram

101-106 steps

In various embodiments, the data being similar means a deviation of each data of the first time-series of energy consumption data to the data of the second time-series of energy consumption data of less than 1%, of less than 5%, of less than 10%, of less than 20%, or of less than 40%. This may be applied to one data, a set of data—e.g. to a “sliding window” of several values—and/or to a correlation of data. This may advantageously serve as a basis for targeted comparing of the data, thus improving the trust in the method's correctness.

In various embodiments, the data being similar means that a trained artificial neural net, ANN, as described below outputs the data of the second time-series of energy consumption data being part of the data of the first time-series of energy consumption data. The ANN, or a part of it, may be called “Pattern Detector”. The “Pattern Detector” is piece of software and/or hardware that is configured to be trained for detecting occurrences of a pattern. The pattern may come from a collection of first energy consumption scenarios, which may be stored in an Operation Database. Within a time series, where by occurrence a sub-series of the of the input time series is meant such that this sub-series is classified into the same quality measure—e.g. class—as the other examples by a suitable classifier, e.g. a recurrent neural network.

In various embodiments, the quality measure comprises an energy consumption class, a quality estimation and/or a measurement result of the energy consumed in this scenario. Accordingly, each first energy consumption scenario comprises a quality measure of this first energy consumption scenario. The quality measure may be provided in an automated and/or a manual way. The quality measure may comprise any value suited for evaluation, e.g. {1; 2; . . . }, {“good”; “average”; “bad”; . . . }, and/or further values. The quality measure may comprise an energy consumption, for instance based on a sum of energy consumptions of the devices involved in a scenario for the duration of the scenario.

In some embodiments, second energy consumption scenarios of essentially the same quality measure are aggregated. Depending on the definition of the “same” quality measure (or class), this may comprise some deviations, e.g. a deviation of 10%, 20%, or others. This aggregation advantageously may help to provide the user with an intuitive understanding how far from an optimum—or, how close it—the behavior of the considered subsystem is.

In various embodiments, the quality measure is attributed. The quality measure may be attributed, for instance, with a comment, a recommendation, a hint, a statement, or the like. The uses may this way get an insight why the examples of this class showcase inefficiency and what can be done to improve operation. This may advantageously be a basis to propose an improvement in cases when, e.g., the energy consumption sum of the at least one device of the first energy consumption scenario is better than of the second energy consumption scenario. On this basis, for example device settings may be changed.

In various embodiments, the at least one device comprises a machine driven by electrical, mechanical, chemical, and/or further energy sources. Examples may be a heater, a cooler, a motor, a computing machine, a loader, a compressor, a pressure-driven device, a device driven by heat energy and/or chemical means such as gas and/or another combustible material. This may contribute to get an overall survey of the “real” energy consumption of a site. Furthermore, this may help to achieve a substantial improvement of the energy consumption.

In some embodiments, the first energy consumption scenario and the second energy consumption scenario comprise energy consumption data of at least two devices. The two devices may be selected manually or automatically, e.g. by an ANN or by a correlation-computing device. This may help to discover apparent and/or hidden correlations, for instance between a heater and a cooler, which may lead to a worsened energy consumption when, e.g., run in parallel in the same room.

In various embodiments, the first energy consumption scenario and the second energy consumption scenario comprise input-data. This may contribute to compare the reaction of several sub-systems. This may, for instance, be a basis to detect that on a rapid temperature-change—or other changes—, some sub-systems may react more energy-efficient than others.

In some embodiments, the input-data comprise environment data, schedule data, production cycle data, and/or other data to influence at least one device of a scenario. Examples may comprise, e.g., weather data, like temperature, sun, rain, humidity, and/or further environment data (e.g., dust). This may include production schedules. Some of them with dedicated length, which may influence the length of an energy consumption scenario. This may include schedules at all, e.g., day/night. Further, it may include data from a Manufacturing Execution System, production cycle data—like: inputting material #1, etc.—and/or many others. This may increase the comparability of scenarios.

In some embodiments, the method comprises a further step: If the second time-series of input-data is similar to more than one first time-series of input-data, namely to a primary and a secondary time-series of input-data of a primary and a secondary energy consumption scenario, outputting the quality measure of the primary and the secondary energy consumption scenario. This may lead to an automatic or semi-automatic improvement of the energy consumption, because it makes apparent if there is a more efficient method for the use of energy. For attributed quality measures, this increase the acceptance, because reasons for the improvements may be provided this way.

An aspect relates to a system for evaluating an energy efficiency of an energy consumption scenario, which is configured to execute a method as described above and/or below.

An aspect relates to an artificial neural network, ANN, which is configured to, in a first learning phase, obtaining a plurality of first energy consumption scenarios, which each comprises a first time series of energy consumption data of at least one device, and a quality measure of the first energy consumption scenario; in a second learning phase, obtaining a plurality of second energy consumption scenarios, which each comprise a second time-series of energy consumption data of at least one device, and a similarity assessment of each second energy consumption scenario to each first energy consumption scenario; in a third learning phase, analyzing the similarity assessments, by the ANN; in a productive phase, applying, by the ANN, the similarity assessments to a newly obtained second energy consumption scenario; and if a similarity assessment of the newly obtained second energy consumption scenario is greater than a predefined value—i.e. on a successful match—outputting the quality measure for the energy efficiency of the scenario.

An aspect relates to a use of a system as described above and/or below for evaluating an energy efficiency of an energy consumption scenario and/or of a site running a plurality of energy consumption scenarios.

For further clarification, the invention is described by means of embodiments shown in the figures. These embodiments are to be considered as examples only, but not as limiting.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for evaluating an energy efficiency of a second energy consumption scenario of a site, the method comprising the steps of:
obtaining a first energy consumption scenario, which comprises a first time-series of energy consumption data of at least one device, and a quality measure of the first energy consumption scenario;
obtaining the second energy consumption scenario, which comprises a second time-series of energy consumption data, wherein the second energy consumption scenario has a same or a shorter duration than the first energy consumption scenario;
comparing the second time-series of energy consumption data to the first time-series of energy consumption data;
when the second time-series of energy consumption data is similar to the first time-series of energy consumption data, outputting the quality measure of the first energy consumption scenario; and
controlling the site's power consumption, based on the quality measure.

2. The method of claim 1, wherein the data being similar means a deviation of each data of the first time-series of energy consumption data to the data of the second time-series of energy consumption data of less than between 1-40%.

3. The method of claim 1, wherein the data being similar means that a trained artificial neural net, ANN, outputs the data of the second time-series of energy consumption data being part of the data of the first time-series of energy consumption data.

4. The method of claim 1, wherein the quality measure comprises an energy consumption class, a quality estimation and/or a measurement result of the energy consumed in this scenario.

5. The method of claim 4, wherein second energy consumption scenarios of essentially the same quality measure are aggregated.

6. The method of claim 1, wherein the quality measure (18) is attributed.

7. The method of claim 1, wherein the at least one device comprises a machine driven by electrical, mechanical, chemical, and/or further energy sources.

8. The method of claim 1, wherein the first energy consumption scenario and the second energy consumption scenario comprise energy consumption data of at least two devices.

9. The method of claim 1, wherein the first energy consumption scenario and the second energy consumption scenario comprise input-data.

10. The method of claim 9, wherein the input-data comprise environment data, schedule data, production cycle data, and/or other data to influence at least one device of a scenario.

11. The method of claim 1, wherein, when the second time-series of input-data is similar to more than one first time-series of input-data, namely to a primary and a secondary time-series of input-data of a primary and a secondary energy consumption scenario, outputting the quality measure of the primary and the secondary energy consumption scenario.

12. An artificial neural net (ANN), which is configured to:
in a first learning phase, obtaining a plurality of first energy consumption scenarios, which each comprises a first time-series of energy consumption data of at least one device, and a quality measure of the first energy consumption scenario;
in a second learning phase, obtaining a plurality of second energy consumption scenarios, which each comprises a second time-series of energy consumption data of at least one device, and a similarity assessment of each second energy consumption scenario to each first energy consumption scenario;
in a third learning phase, analyzing the similarity assessments, by the ANN;
in a productive phase, applying, by the ANN, the similarity assessments to a newly obtained second energy consumption scenario; and
when a similarity assessment of the newly obtained second energy consumption scenario is greater than a predefined value, outputting the quality measure for the energy efficiency of the scenario.
